(19) United States
(12) Patent Application Publication
(10) Pub. No.: US 2002/0118170 A1
(43) Pub. Date: Aug. 29, 2002

(54) Solid state motion tracking system

(76) Inventors: Daniel M. Iaria, Indianapolis, IN (US); David M. Torski, Perrusville, OH (US)

Correspondence Address: Woodard, Emhardt, Naughton, Moriarty and McNett, Bank One Center/Tower, 111 Monument Circle, Suite 3700, Indianapolis, IN, 46204-5137, US

(21) Appl. No.: 09/794,988

(22) Filed: Feb. 27, 2001

(51) Int. Cl. G09G 5/08

(52) U.S. Cl. 345/163

(57) ABSTRACT

A motion tracking system includes a processor, a heat source generator operatively coupled to the processor, and a heat sensor operatively coupled to the processor. As the system moves along a surface, the heat source generator generates a heated area on the surface. The heat sensor senses the heated area on the surface, and the processor determines the movement of the heat sensor relative to the surface based on the heated area. The processor in one mode determines the relative direction of movement by comparing the location of a pulsed heated area relative to a reference location. In another mode, the processor determines the relative direction by comparing the location of a thermal dissipative zone to the location of a hot zone of a continuously heated area.

### BACKGROUND OF THE INVENTION

The present invention generally relates to motion tracking systems, and more specifically, but not exclusively, concerns a solid state motion tracking system.

Motion tracking systems are used in a wide variety of situations such as for tracking the motion of computer input devices and tracking the motion of palettes along a conveyer. One type of computer input (pointing) device is a mouse. A traditional system typically uses a mechanical system for motion tracking. This mechanical system has mouse ball that contacts a surface, such as a desktop or a mouse pad. The mouse ball also contacts rollers that are attached to encoders. When the mouse moves along the surface, the mouse ball rolls, and this in turn spins the rollers. The encoder wheels convert the movement of the rollers into electronic signals that are translated into movement of a cursor on a computer screen. Many problems plague these types of mechanically driven motion tracking systems. For example, the mouse ball tends to pick up dirt and dust that stick to the rollers. These encrusted rollers tend to jam. In addition, the mechanical parts are prone to wear, and this wearing tends to reduce motion tracking precision.

One attempt to solve these problems has been the development of a solid state motion tracking system that tracks the movement of surface details under the mouse. In one such system, an optical sensor/camera takes a series of photographs of the surface beneath the mouse. The surface details in the pictures are analyzed. Any changes in position of the surface details are translated into movement of the mouse. Although this type of motion tracking system eliminates mechanical parts, the system requires that the surface have visible details that can be tracked. If the surface does not have visible details or the surface tends to reflect light, such as with glass, the motion tracking system may not be able to track motion. In addition, such systems experience problems with tracking highly repetitive patterned surfaces, such as printed photographs from magazines or newspapers.

In another type of a solid state motion tracking system, a special surface containing sensors is used to track the motion of a pointing device. The pointing device for this system can not be tracked along surfaces external to this special surface. Therefore, there has been a long felt need for a solid state motion tracking system that can track motion on a large number of different surfaces.

### SUMMARY OF THE INVENTION

One form of the present invention is directed to a unique motion detection system. The system includes a heat source generator for generating a heated area on a surface. A heat sensor is coupled to the heat source generator, and the heat sensor senses the heated area on the surface. The heat sensor is adapted to move in close proximity along the surface. A processor is operatively coupled to the heat sensor in order to determine movement of the heat sensor relative to the surface based on the heated area.

Another form of the present invention is directed to a unique method for motion detection. An area on a surface is heated, and the heated area on the surface is sensed with a heat sensor that is moveable in close proximity along the surface. Movement of the heat sensor along the surface is determined based on the heated area.

A further form of the present invention concerns a computer input device. The device includes a body member and a heat source generator coupled to the body member. The heat source generator generates a heated area on a surface. A heat sensor is coupled to the body member and senses the heated area on the surface. A processor is operatively coupled to the heat sensor. The processor determines the movement of the body member relative to the surface based on the heated area.

### BRIEF DESCRIPTION OF THE DRAWINGS

FIG. 1 is a block diagram of a motion tracking system according to one embodiment of the present invention.

FIG. 2 is a partial cross-sectional view of a motion tracking system according to another embodiment of the present invention.

FIG. 3 is an enlarged view of a heated area shown in FIG. 2.

FIG. 4 is a flow diagram illustrating a pulse mode motion tracking method according to one embodiment of the present invention.

FIG. 5 is a view of a thermal image in which the heated area is aligned with a reference location.

FIG. 6 is a view of a thermal image when the motion tracking system is moved.

FIG. 7 is a flow diagram illustrating a pulse mode motion tracking method according to another embodiment of the present invention.

FIG. 8 is a view of a thermal image in which the heated area is at a first position.

FIG. 9 is a view of a thermal image in which the heated area is at a second position.

FIG. 10 is a flow diagram illustrating a continuous mode motion tracking method according to a further embodiment of the present invention.

FIG. 11 is view of a thermal image for the continuous mode motion tracking method.

FIG. 12 is a view of a thermal image for a motion tracking method that uses both the pulse mode method and the continuous mode method.

FIG. 13 is a flow diagram illustrating a process for calibrating the motion tracking system according to one embodiment of the present invention.

FIG. 14 is a perspective view of a computer system having a mouse with a motion tracking system according another embodiment of the present invention.

FIG. 15 is a partial cross-sectional view of the mouse shown in FIG. 14.

### DESCRIPTION OF SELECTED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the art that some of the features which are not relevant to the invention may not be shown for the sake of clarity.

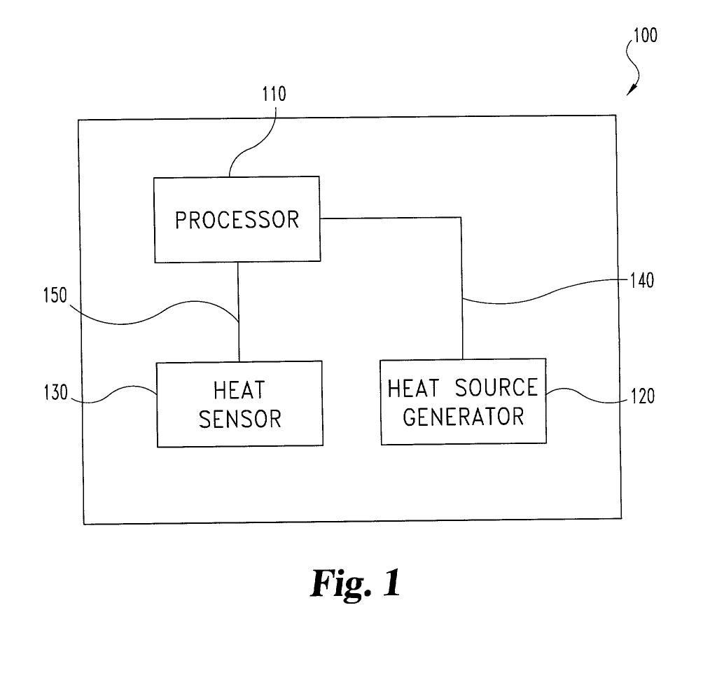

A block diagram illustrating one embodiment of a motion tracking system 100 according to one embodiment of the present invention is shown in FIG. 1. The motion tracking system 100 includes a processor 110, a heat source generator 120, and a heat sensor 130. The processor 110 is operatively coupled to the heat source generator through channel 140, and the processor 110 is operatively coupled to the heat sensor 130 through channel 150. The processor 110 can be operatively coupled to generator 120 and sensor 130 using electrical connections, fiber optic connections, radio transmissions, and in other manners generally known by those skilled in the art. It should be understood that the components can be operatively coupled directly together and/or indirectly through other components.

The processor 110 may be comprised of one or more components configured as a single unit. For a multi-component form of the processor 110, one or more components can be located remotely relative to the others. One or more components of the processor 110 may be of the electronic variety defining digital circuitry, analog circuitry, or both. The processor 110 may incorporate software for processing information received from the heat sensor 130. By way of non-limiting example, the processor 110 can include a microprocessor, a printed circuit board with multiple components provided thereon, a computer, an integrated circuit, and/or any combination thereof. In one embodiment, the processor 110 is a microprocessor, and in still yet another embodiment, the processor 110 is an image processing microprocessor.

The heat source generator 120 may also be comprised of one or more components configured as a single unit. In one embodiment, the heat source generator 120 is an infrared (IR) emitter. It should be appreciated, however, that the heat source generator 120 can include other types of heat generators generally known by those skilled in the art. The heat sensor 130, likewise, may be comprised of one or more components configured as a single unit. The heat sensor 130 in one embodiment is an IR sensor. Further, it should be understood that heat sensor 130 can include other types of heat sensing/imaging devices generally known by those skilled in the art. It should be further appreciated that the processor 110, the heat source generator 120, the heat sensor 130, and any combination thereof can be integrated into a single unit such as a microprocessor. In one particular embodiment, the components 110, 120 and 130 are operatively coupled together on a printed circuit board.

The processor 110 can control the heat supplied by heat source 120, and the processor 110 processes the information sent from the heat sensor 130. The processor 110 uses this information sent by the heat sensor 130 to determine the relative motion of motion tracking system 100. The processor 110 can then output the relative motion information to another system, such as a computer.

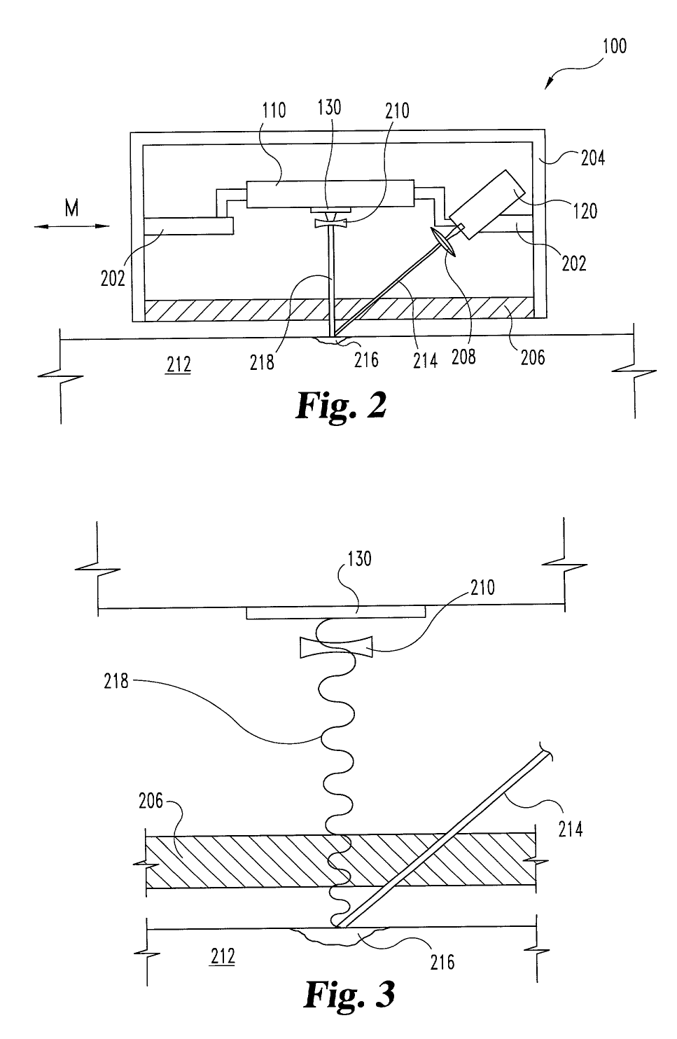

A partial cross-sectional view of the motion tracking system 100 according to one embodiment of the present invention is shown in FIG. 2. The motion tracking system 100 includes the processor 110, the heat source generator 120 and the heat sensor 130. The heat sensor 130 is mounted onto processor 110. The processor 110 along with the heat source generator 120 are mounted to a printed circuit board 202. The system 100 is encased within body member or housing 204. An optional view window 206 encloses the system 100 within housing 204. The view window 206 protects the system 100 from outside contaminants while at the same time is at least partially thermally transparent. It should be understood that instead of being at least partially transparent, the view window 206 can include at least one hole through which heat can pass.

The system 100 further has a focusing lens 208 that is adjacent to the heat source generator. A magnification lens 210 is provided adjacent to the heat sensor 130. It should be appreciated that the focusing lens 208 can be integrated into the heat source generator 120, and the magnification lens 210 can be incorporated into the heat sensor 130. The system 100 is able to move along in directions M along a surface 212.

As illustrated in FIGS. 2-3, heat source generator 120 generates a beam of energy 214 that is focused with the focusing lens 208 onto the surface 212. In the illustrated embodiment, the heat source generator 120 is angled relative to the heat sensor 130 in order to generate the heated area 216 directly below the heat sensor 130. In one embodiment, this energy beam 214 is an infrared beam. However, it should be understood that the heat source generator 120 can generate other forms of radiation in order to heat the surface 212. Further, the heat source generator 120 can heat the surface 212 in other generally known manners, such as through conduction, induction and convection.

The energy beam 214 creates a thermally heated area 216 on the surface 212. The heated area 216 has a temperature greater than the temperature of the surrounding portion of the surface 212. This heated area 216 on the surface 212 radiates heat 218. The radiated heat 218 is magnified with the magnification lens 210 onto the heat sensor 130. The heat sensor 130 generates a thermal image of a portion of the surface 212 beneath the heat sensor. This image is then processed by the processor 110 in order to determine the relative movement of the system 100 relative to the surface 212.

The heated area 216 has a temperature slightly greater than the temperature of the surrounding surface 212. This temperature of the heated area 216 should be high enough so that the sensor 130 can detect the heated area 216. In one form, the temperature generated by the heat source generator 120 is approximately between 20° C. to 50° C. It should be understood that this temperature range can vary depending on conditions such as the sensitivity of the heat sensor 130, ambient temperatures, thermal conductivity of the surface 212, and environmental conditions. For safety, this temperature range should be below the ignition temperatures of commonly used home/business items and should be below temperatures at which a person may be burned.

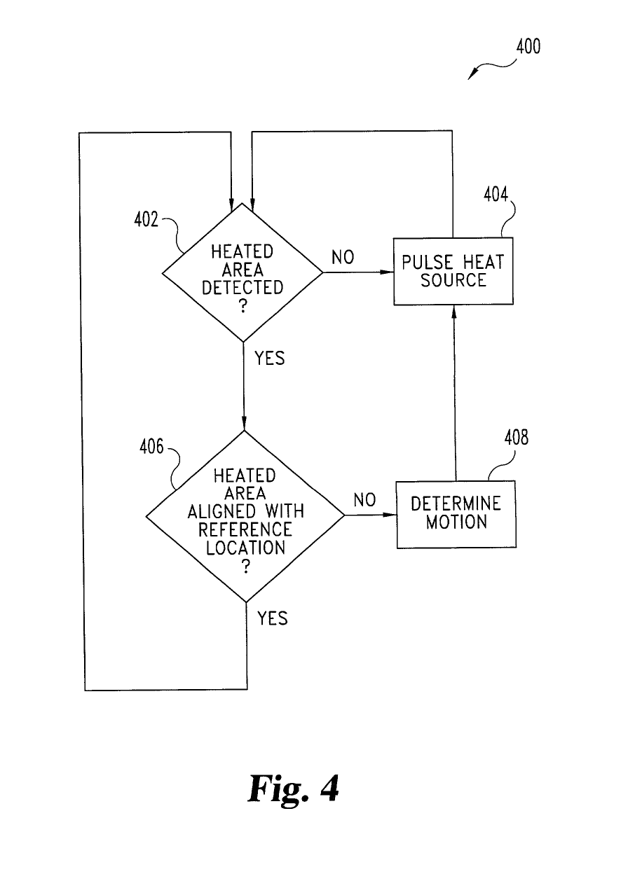

One method of motion tracking according to one embodiment of the present invention will now be described with reference to FIGS. 4-6. In this particular embodiment, the system uses a “pulse mode” motion detection method. The heat source generator 120 generates pulses of heat on the surface 212. The pulsed heated areas 216 are then used to determine the motion of the sensor 130 relative to the surface 212.

A flow diagram 100 illustrating this method of tracking motion is shown in FIG. 4. In stage 402, the processor 110 determines if the heated area 216 has been detected. The heat source generator 120 generates a pulse of energy 214 in stage 404 if the heated area 216 is not detected. Following this heat pulse, the processor 110 determines again whether the heated area 216 has been detected. If the heated area 216 has been detected, then in stage 406 the processor 110 determines whether the heated area 216 is aligned with a reference location.

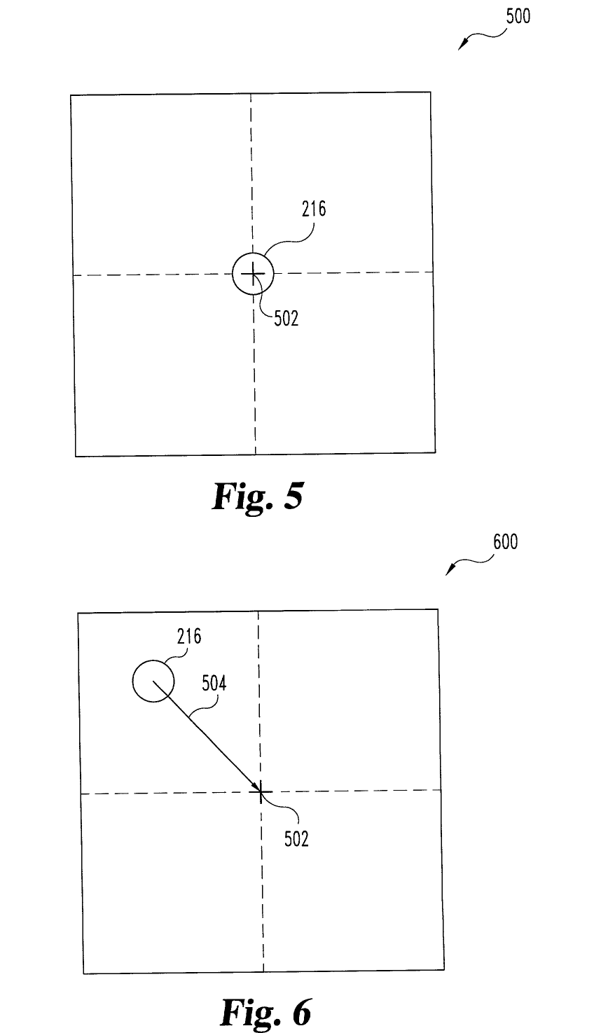

An example of a thermal image 500 of the surface 212 beneath the heat sensor 130 is shown in FIG. 5. This image 500 is shown from the perspective of the heat sensor 130. The image 500 has a reference location 502. It should be understood that the reference location 502 is shown in the drawings for the sake of clarity. The image 500 in actual practice may not actually have the reference location marked on the image 500. As shown in FIG. 5, the heated area 216 is aligned with the reference location 502. This indicates that the system 100 has not moved relative to the heated area 216. In such a case, as shown in FIG. 4, the processor 110 in stage 406 cycles back to the heated area detection stage 402.

When the heated area 216 in stage 406 is not aligned with the reference location 502, the processor 110 then proceeds to stage 408 in which the relative motion of the heat sensor 130 is determined. As shown in thermal image 600 in FIG. 6, the heated area 216 is not aligned with the reference location 502. The processor 110 determines the relative motion of the heat sensor by calculating a direction indicator 504. Direction indicator 504 is determined by computing the location of the heated area 216 relative to the location of the reference location 502. In the embodiment shown, the reference location 502 is located in the center of the images 500 and 600. This reduces the chance that the heated area 216 will move out of the image 500 before the heated area can be detected. It should be noted, however, that the reference location can be located in other areas besides the center of the images 500 and 600. The reference location 512, for example, may be located off center when the system 100 prevalently travels in one direction.

The processor 110 may also determine the velocity of the heat sensor 130 relative to the surface 212. In one embodiment, the processor 110 measures the time interval between when the heat is pulsed and when the image 600 is generated. The processor 110 further computes the distance from the reference location 502 to the heated area 216. With this information, the processor 110 then can convert the direction indicator 504 into a velocity vector.

After the direction 504 is determined in stage 408, the heat source generator 120 pulses heat again in stage 404. When generated, the heated area 216 is located directly beneath the reference location 502 so that a stationary condition can be detected in stage 406. If the system 100 is moved away from the surface 212 such that the heated area 216 is not created and/or detected, the heat source 120 will constantly pulse (stage 404) and no relative motion will be detected. As soon as the sensor 130 comes into close proximity with the surface 212 such that the heated area 216 is detectable, then motion tracking can resume.

It should be appreciated that the present invention is particularly useful for close proximity motion detection. As the heat sensor 130 moves farther away from the surface, the sensitivity of the system 100 in detecting small movements reduces. The proximity between the surface 212 and the heat sensor 130 can depend on the requirements for the particular application. In one particular embodiment, the heat source generator 120 and the heat sensor 130 are located at a distance approximately between 0-30 mm from the surface 212.

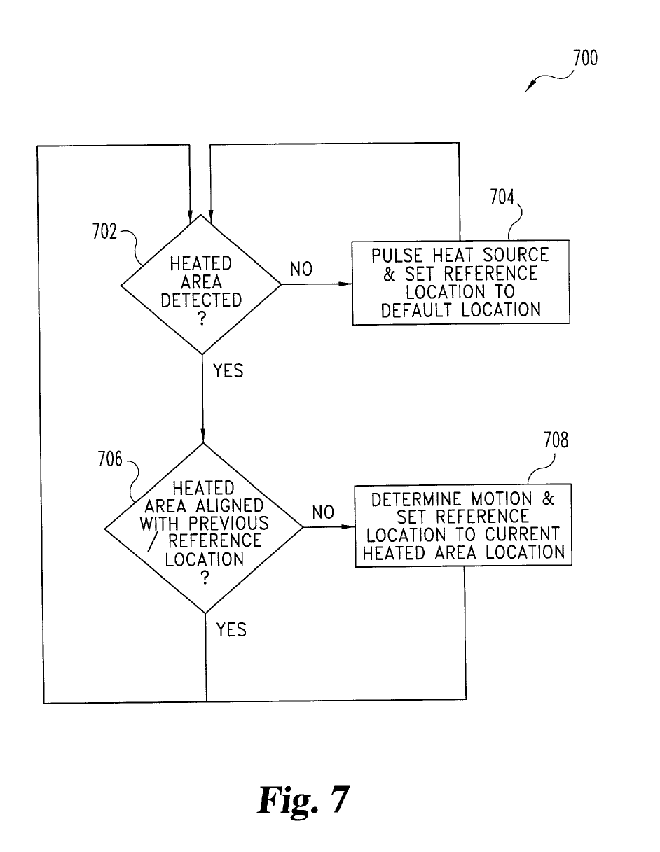

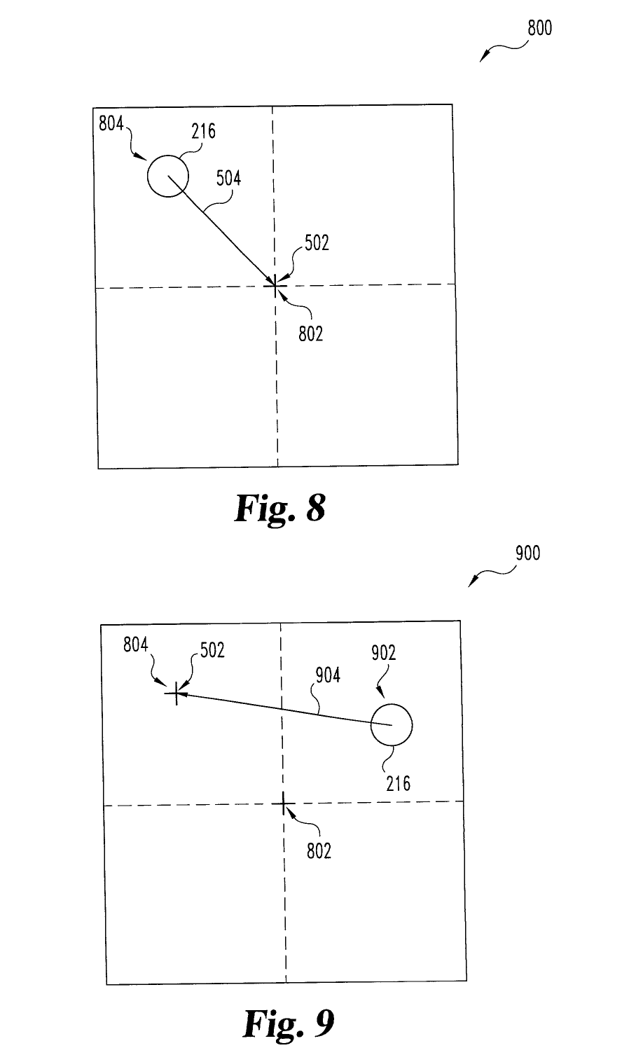

A pulse mode motion tracking method according to another embodiment of the present invention will now be described with reference to FIGS. 7-9. In stage 702 shown in flow diagram 700, the processor 110 determines whether the heated area 216 has been detected. If the heated area 216 has not been detected, the heat source generator 120 then generates the pulse of energy 214 in stage 704. Further, in stage 704, the processor sets the reference location 502 to a default (absolute coordinate) location 802. The reference location 502 is used to determine the location of the heated area 216. As shown in thermal image 800 in FIG. 8, the reference location 502 is set to a default location 802. In this particular embodiment, the default location 802 is in the center of the image 800. The default location 802 can be located in other areas besides the center of the image. The default location 802 is used set a basis for a coordinate system in the image 800.

When the processor 110 in stage 702 detects a heat source, the processor 110 in stage 706 determines whether the heated area 216 is aligned with the reference location 502. If the heated area 216 is aligned with the reference location 502, then the processor 110 again determines whether the heated area 216 is again detectable in stage 702. When the heated area 216 is not aligned with the reference location 502, the relative motion of the heat sensor 130 is determined in stage 708. As shown in FIG. 8, the direction 504 is determined by comparing the position of the heated area 216 with the reference location 502. Once the direction 504 is determined, the processor 110 sets the reference location 502 to the current (first) location 804 of the heated area 216. In this particular embodiment, instead of pulsing heat again after stage 708, the heat sensor 130 takes another thermal image of the surface 212 and the processor 110 determines whether the heated area 216 is detected. This reduces the number of energy pulses, which in turn reduces energy consumption for the system 100.

When the heated area 216 is again detected in stage 702, the processor 110 determines whether the heated area 216 is aligned with the current reference location 502, which is now at the first location 804 (FIG. 9). As shown in thermal image 900, the processor 110 in stage 708 determines the motion of the system 100 based on the current (second) location 902 of heat source 216 relative to the current reference location 502. New direction 904 is based on the second location 902 of heated area 216 relative to the current reference location 502. After the new direction 904 is determined, the reference location 502 is then set to the current (second) location 902 of heated area 216. It should be appreciated that the above described method can also be accomplished by having the processor 110 set flags in stage 704 to indicate that the reference location 502 is the default location 802.

This particular pulse mode motion detection method, in which energy is pulsed only when the heated area 216 is undetectable, helps to reduce energy consumption by reducing the number of energy pulses generated. Further, this particular method can reduce the amount of thermal background noise and minimize heating of the surface 212. In another embodiment, the timing between energy pulses can be reduced when the heated area 216 has not been detected for a predetermined time limit. The time limit would indicate that the system 100 is not close to the surface 212. The pulsing and imaging rate of the system 100 can also vary depending on the thermal characteristics of the surface 212.

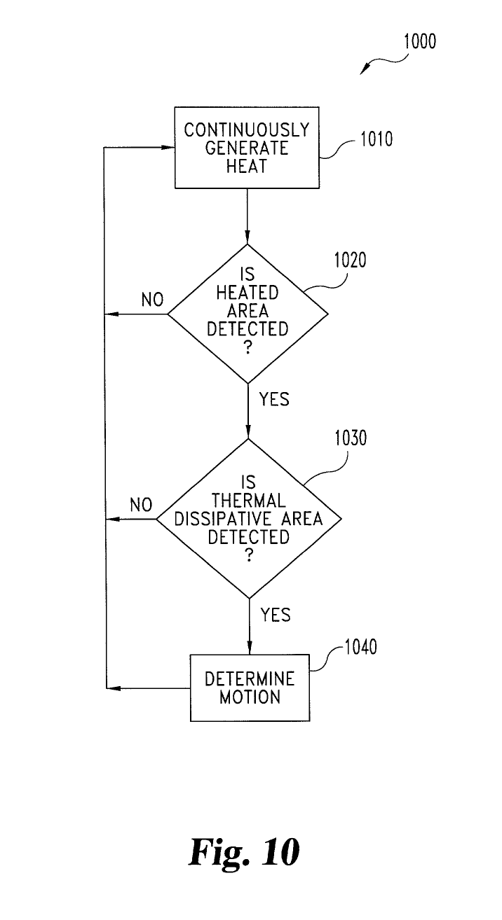

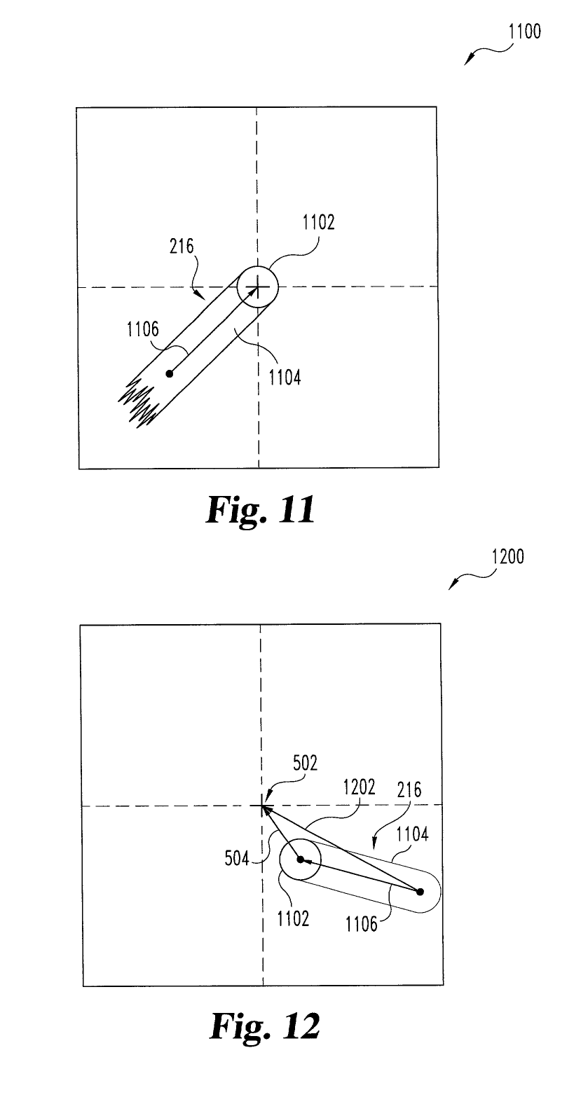

In another embodiment for a method of motion tracking, which will now be described with reference to FIGS. 10-11, the system 100 generates a continuous energy beam 214 in order to continuously heat the surface 212. As shown in flow diagram 1000 (FIG. 10), the heat source generator 120 continuously generates heat in stage 1010. As illustrated in FIG. 11, the heat sensor 130 generates a thermal image 1100. In stage 1020, the processor 110 determines whether the heated area 216 is detectable. If the heated area 216 is undetectable, the heat source generator 120 continues to generate heat.

When the heated area 216 is detected, the processor 110 in stage 1030 determines if a thermal dissipative zone is detectable. As shown in FIG. 11, when the system 100 is moved along the surface 212, the heated area 216 has a hot zone 1102 and a thermal dissipative zone 1104. The hot zone 1102 is directly heated by the heat source generator 120, and therefore, the hot zone 1102 is the hottest location in the thermal image 1100. The portion of the heated area 216 that is no longer not directly heated by the heat source generator 120 eventually cools to form the thermal dissipative zone 1104. The system 100 defines the thermal dissipative zone as a specified temperature gradient below the temperature of the hot zone 1102. This limit should be greater than the ambient temperature of the surface 212. It should be appreciated that his limit can be adjusted depending on environmental conditions and the sensitivity of the heat sensor 130.

In stage 1040, the system 100 determines the relative motion by comparing the hot zone 1102 with the location of the thermal dissipative zone 1104. Direction 1106 shown in FIG. 11 represents the direction of movement. Velocity of the heat sensor 130 can be calculated based on time intervals between successive images and the distance between the length of the heated area 216.

Thermal image 1200 in FIG. 12 illustrates a method of motion detection according to still yet another embodiment of the present invention. This motion detection method combines the pulse mode method with the continuous mode method. The heat source generator 120 heats to the surface 212 for a specified duration and then ceases to heat the surface 212. The resulting heated area 216 has a hot zone 1102 and a thermal dissipative zone 1104. The processor 110 then determines from the thermal image 1200 the motion of the system 110. The processor 110 determines the pulse mode direction 504 based on the location of the heated area 216 relative to the reference location 502. The processor 110 further determines the continuous mode direction 1106 based on the orientation of the dissipative zone 1104 in relation to the hot zone 1102. The directions 504 and 1106 are then combined to generate a resulting direction 1202. It should be appreciated that this method combines the benefits of the pulse mode method with the benefits of the continuous mode method.

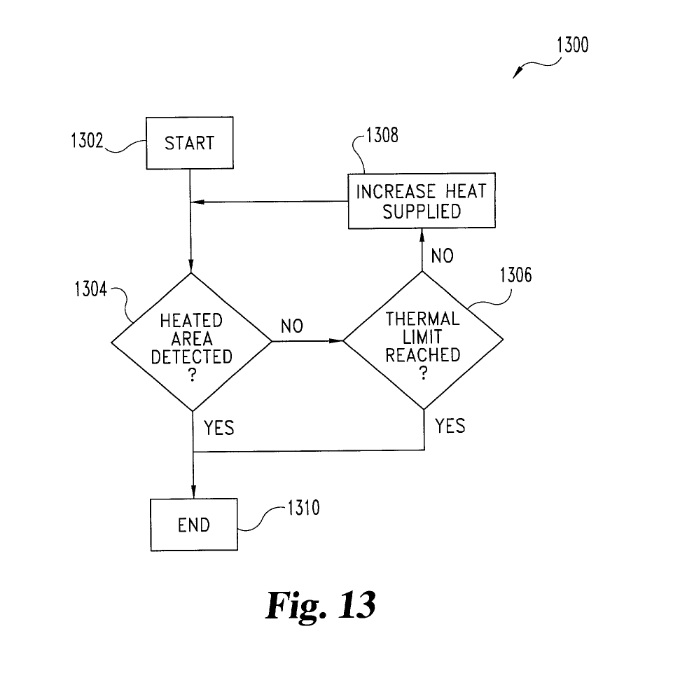

Thermal conductivity of the surface 212 may affect the ability of the sensor 130 to detect the heated area 216. A method of calibrating the heat source generator 120 according to one embodiment of the present invention is illustrated in flow chart 1300 shown in FIG. 13. This method of calibration can be incorporated into the pulse mode method and/or the continuous mode method. After initial stage 1302, the processor 110 determines whether the heated area 216 is detectable in stage 1304. When the heated area 216 is undetectable, the processor 110 determines if the heat source generator is at a predetermined thermal/temperature limit in stage 1306. This thermal limit can be based on safety conditions such as ignition/burn temperatures of common items and skin burning temperatures, to name a few.

If the thermal has not been reached, the heat supplied by the heat source generator is then increased in stage 1308. The processor 110 again in stage 1304 determines whether the heated area 216 detectable. When the heated area 216 has been detected or the thermal limit has been reached, then the calibration process ends in stage 1310. It should be appreciated that this calibration process can be constantly repeated in order to improve motion tracking accuracy.

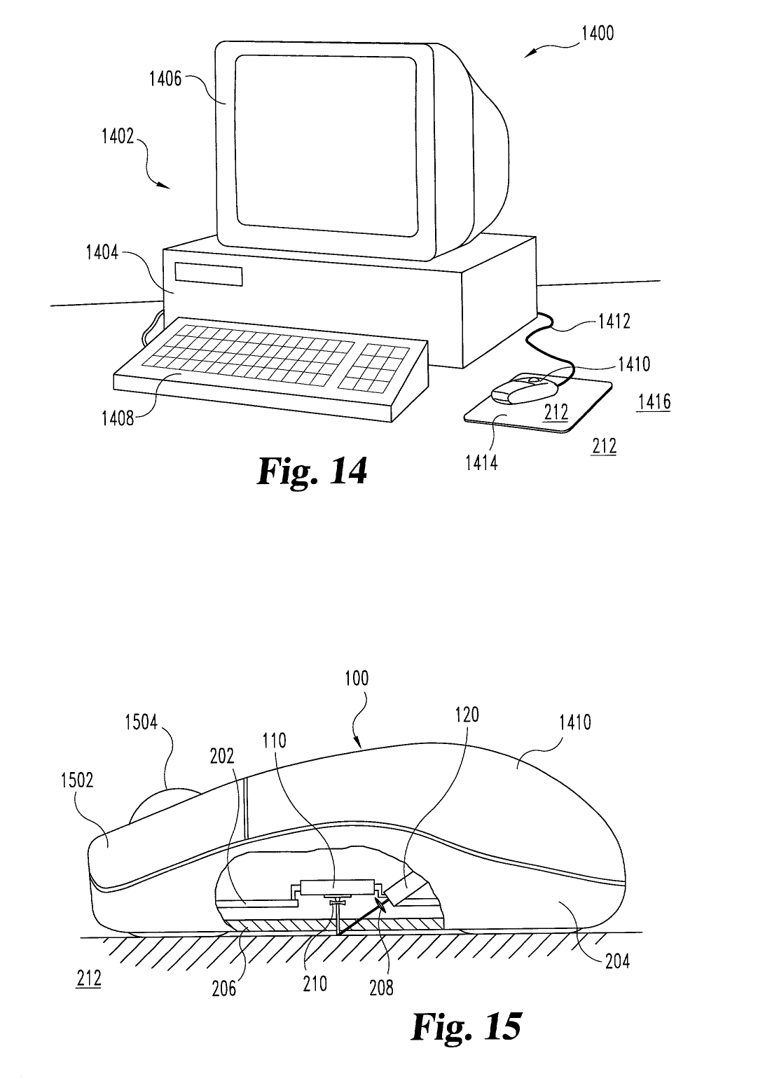

In one specific embodiment of the present invention, as shown in FIG. 14, the motion tracking system 100 is incorporated into a computer system 1400. The computer system 1400 includes a computer 1402. The computer 1402 can include a personal computer, a computer terminal, a person digital assistant (PDA), and/or other types of devices generally known to those skilled in the art. In the illustrated embodiment, the computer 1402 is a personal computer. The computer 1402 includes a processor unit 1404, a display 1406 coupled to processor unit 1404 and a computer keyboard 1408. It should be appreciated that the computer system 1400 can have other types generally known devices, such as a printer and a scanner.

The computer system 1400 further includes a computer input device 1410 that incorporates the motion tracking system 100. In the illustrated embodiment, the input device 1410 is a computer mouse. However, it should be understood that the motion tracking system 100 can be incorporated into other input devices that are generally known by those skilled in the art, such as an input pen. The mouse 1410 is operatively coupled to the computer 1402 through a cable 1412. The mouse 1410 can also be operatively coupled to the computer 1402 in other manners generally known by those skilled in the art, such as through radio transmissions.

As shown, the surface 212 on which the mouse 1410 is used can include a mouse pad 1414 and a desktop 1416. One of the main benefits of the present invention is that the motion tracking system 100 can be used on a wide variety of surfaces. It should be understood that the mouse 1410 can be used on other types of surfaces besides the ones shown in FIG. 14. In one embodiment, the mouse pad 1414 is a typical mouse pad. In another embodiment, the mouse pad 1414 has a specific thermal conductivity in order to improve the accuracy of tracking the mouse 1410. One key benefit of the present invention is that the mouse 1410 can function even if the surface 212 is blank or has a repeating pattern.

A partial cross-sectional view of the mouse 1410 that incorporates the motion tracking system 100 is shown in FIG. 15. The mouse 1410 includes typical features such as a mouse button 1502 and a wheel 1504 for scrolling. It should be appreciated that the mouse 1410 can have multiple mouse buttons 1502 and can include other types of generally known input interfaces. In the illustrated embodiment, all of the components are housed within the mouse 1410, and the mouse 1410 generates a standard output that is sent to the computer 1402. In another embodiment, the processor 110 is incorporated into the processing unit 1404 and/or software is used to determine the motion of the mouse. While the motion tracking system 100 has been described with reference to a computer input device, it should be understood that the motion tracking system can be used in a wide variety of other situations.

While specific embodiments of the present invention have been shown and described in detail, the breadth and scope of the present invention should not be limited by the above described exemplary embodiments, but should be defined only in accordance with the following claims and their equivalents. All changes and modifications that come within the spirit of the invention are desired to be protected.

What is claimed is:

1. A motion detection system, comprising:
a heat source generator to generate a heated area on a surface;
a heat sensor coupled to said heat source generator to sense said heated area on said surface, said heat sensor being adapted to move in close proximity along said surface; and
a processor operatively coupled to said heat sensor to determine movement of said heat sensor relative to said surface based on said heated area.

2. The system of claim 1, further comprising a focusing lens provided adjacent to said heat source generator for focusing heat generated by said heat source generator onto said surface.

3. The system of claim 1, further comprising a magnification lens provided adjacent to said heat sensor for magnifying heat onto said heat sensor.

4. The system of claim 1, wherein said heat source generator includes an infrared emitter.

5. The system of claim 1, wherein said heat sensor includes an infrared sensor.

6. The system of claim 1, wherein said processor includes a microprocessor.

7. The system of claim 1, wherein said processor includes a thermal imaging microprocessor.

8. The system of claim 1, wherein said heat source generator is adapted to pulse heat.

9. The system of claim 1, wherein said processor determines movement of said heat sensor by comparing a location of said heated area relative to a reference location.

10. The system of claim 1, wherein said heat source generator is adapted to continuously generate heat.

11. The system of claim 1, wherein said processor determines movement of said heat sensor by comparing a hot zone of said heated area with a dissipative zone of said heated area.

12. The system of claim 1, wherein said heat source generator is adapted to generate continuous heat and pulsed heat.

13. The system of claim 1, wherein said processor determines movement of said heat sensor by comparing a location of said heated area relative to a reference location and by comparing a hot zone of said heated area with a dissipative zone of said heated area.

14. The system of claim 1, further comprising a computer input device in which said heat source generator and said heat sensor are incorporated.

15. The system of claim 14, wherein said processor is incorporated into said computer input device.

16. The system of claim 14, wherein said computer input device includes a mouse having at least one button.

17. The system of claim 1, further comprising a printed circuit board coupling said heat source generator to said heat sensor.

18. The system of claim 1, further comprising a body member coupling said heat source generator to said heat sensor.

19. The system of claim 1, further comprising a computer having said processor provided therein.

20. The system of claim 1, wherein said heat source generator is oriented at an angle with respect to said heat sensor to generate said heated area on said surface directly below said heat sensor.

21. The system of claim 1, further comprising said surface.

22. A motion detection method, comprising:
heating an area on a surface;
sensing the heated area on the surface with a heat sensor moveable in close proximity along the surface; and
determining movement of the heat sensor along the surface based on the heated area.

23. The method of claim 22, wherein said heating includes pulsing heat onto the surface.

24. The method of claim 22, wherein said determining includes comparing a location of the heated area relative to a reference location.

25. The method of claim 22, wherein said heating includes emitting continuous heat onto the surface.

26. The method of claim 22, wherein said determining includes comparing a location of a hot zone of the heated area with a location of a dissipative zone of the heated area.

27. The method of claim 26, wherein said determining further includes comparing a location of the heated area relative to a reference location.

28. The method of claim 22, further comprising calibrating the heat sensor.

29. The method of claim 28, wherein said calibrating includes reheating the surface when the heated area is undetectable.

30. The method of claim 28, wherein said calibrating includes increasing heat supplied to the surface when the heated area is undetectable.

31. The method of claim 22, further comprising:
providing a body member having the heat sensor and a heat source generator coupled to the body member; and
wherein said heating includes generating heat with the heat source generator.

32. The method of claim 31, wherein the body member is a mouse housing.

33. The method of claim 22, further comprising sending an output corresponding to the movement to a computer.

34. The method of claim 22, wherein said sensing includes imaging a zone on the surface in close proximity to the heat sensor.

35. The method of claim 22, further comprising providing the heat sensor, wherein the heat sensor includes an infrared sensor.

36. A computer input device, comprising:
a body member;
a heat source generator coupled to said body member to generate a heated area on a surface;
a heat sensor coupled to said body member to sense said heated area on said surface; and
a processor operatively coupled to said heat sensor to determine movement of said body member relative to said surface based on said heated area.

37. The device of claim 36, wherein said body member includes a printed circuit board.

38. The device of claim 36, wherein said body member includes a mouse housing.

39. The device of claim 38, wherein said mouse housing includes at least one mouse button.

40. The device of claim 36, wherein said heat source generator includes an infrared emitter.

41. The device of claim 36, wherein said heat sensor includes an infrared sensor.

42. The device of claim 36, wherein said processor includes a microprocessor.

43. The device of claim 36, wherein said processor determines movement of said body member by comparing a location of said heated area relative to a reference location.

44. The device of claim 36, wherein said processor determines movement of said body member by comparing a hot zone of said heated area with a dissipative zone of said heated area.

45. The device of claim 36, wherein said processor determines movement of said body member by comparing a location of said heated area relative to a reference location and by comparing a hot zone of said heated area with a dissipative zone of said heated area.

46. The device of claim 36, further comprising a focusing lens coupled to said body member for focusing heat generated by said heat source generator onto said surface.

47. The device of claim 36, further comprising a magnification lens coupled to said body member for magnifying heat onto said heat sensor.

48. The device of claim 36, further comprising said surface.

49. The device of claim 48, wherein said surface includes a computer mouse pad.

50. The device of claim 36, further comprising a scroll wheel coupled to said body member.
